(19) United States
(12) Patent Application Publication
(10) Pub. No.: US 2023/0332453 A1
(43) Pub. Date: Oct. 19, 2023

(54) DOOR APPARATUS

(71) Applicant: THE GREET INC, Seoul (KR)

(72) Inventor: Woo Jeong YANG, Seoul (KR)

(21) Appl. No.: 18/011,644

(22) PCT Filed: Aug. 29, 2022
(86) PCT No.: PCT/KR2022/012861

§ 371 Date: Dec. 20, 2022

(30) Foreign Application Priority Data
Apr. 18, 2022 (KR) 10-2022-0047447

(51) Int. Cl. E05F 15/40

(52) U.S. Cl. CPC E05F 15/40; E05Y 2201/652; E05Y 2201/668; E05Y 2201/684; E05Y 2400/44; E05Y 2400/54; E05Y 2900/602

(57) ABSTRACT

According to an embodiment of the present invention, a door apparatus is provided. The door apparatus includes: a door unit moving between a first position for closing an accommodation part, which at least temporarily accommodates an object, and a second position for opening the accommodation part; a driving unit coupled to the door unit to move the door unit; and a guide unit provided on both sides of an inlet of the accommodation part to guide the movement of the door unit, wherein the door unit is disposed at the inlet of the accommodation part at the first position to close the accommodation part, and is disposed at an inner upper end of the accommodation part at the second position to open the accommodation part.

### TECHNICAL FIELD

The present invention relates to a door apparatus.

### BACKGROUND ART

The plastic production all over the world has been explosively raised from 1,500,000 ton in 1950 to 397,000,000 ton in 2020. Moreover, recently, plastic usage is more explosively increasing due to the prolonged COVID-19. However, unlike the recognition that plastic is recyclable, the average OECD recycling rate is very low to about 34%. Because of the plastic recycling problem, policies are gradually changed to induce a decrease in plastic consumption even in Korea.

For example, in Korea, the use of plastic cups, plastic straws or the likes in stores is prohibited. Accordingly, in a case in which a customer pays a deposit, a worker in a store provides a reusable container. When the customer returns the reusable container, the worker refunds the deposit. When a customer uses a reusable container, the quantity of stores providing discount benefit is gradually increasing. However, such a reusable container has several disadvantages in that it requires lots of manpower or time to collect reusable containers and in that a collection rate is low.

In order to solve such a problem, recently, a large-scaled café enterprise has provided a service providing multi-use containers for free after installing container collecting apparatuses capable of returning the multi-use containers in stores. In a case of the installed container collecting apparatus, a door unit moves vertically to open and close an inlet. However, in a case in which the door unit opens and closes the inlet while moving vertically, the container collecting apparatus must have a space for accommodating and moving the door. Accordingly, the container collecting apparatus has a disadvantage in that space application is insufficient and the size of the apparatus is increased. In order to solve the problem, the door unit must rotate inward inside an accommodation part and must be accommodated in the accommodation part. However, in a case in which the door rotates inward, the door unit gets the container down or moves the container in a state in which the container is inserted into the accommodating part.

### DISCLOSURE

### Technical Problem

Accordingly, the present invention has been made in view of the above-mentioned problems occurring in the related art, and it is an object of the present invention to provide a door apparatus.

Technical objects to be achieved by the present invention are not limited to the above-described objects and other technical objects that have not been described will be evidently understood by those skilled in the art from the following description.

### Technical Solution

To accomplish the above-mentioned objects, according to the present invention, there is provided a door apparatus. The door apparatus includes: a door unit moving between a first position for closing an accommodation part, which at least temporarily accommodates an object, and a second position for opening the accommodation part; a driving unit coupled to the door unit to move the door unit; and a guide unit provided on both sides of an inlet of the accommodation part to guide the movement of the door unit, wherein the door unit is disposed at the inlet of the accommodation part at the first position to close the accommodation part, and is disposed at an inner upper end of the accommodation part at the second position to open the accommodation part.

Moreover, in a case in which the door unit moves from the first position to the second position, the upper end of the door unit moves toward the inside of the accommodation part and the lower end thereof moves toward the upper side of the inlet, so that the door unit overlaps the inside of the accommodation part only at a predetermined height or more.

Furthermore, the rear surface of the door unit facing the inside of the accommodation part at the first position is arranged to face downward from the second position.

Additionally, at least one guide protrusion is formed at a lower end of a side surface of the door unit, and at least one guide groove into which the guide protrusion is inserted is formed along an inner surface of the guide unit.

In addition, the guide groove includes: a first end region into which the guide protrusion is inserted at the first position; a second end region in which the guide protrusion is inserted at the second position; and a connection region connecting the first end region and the second end region, wherein the connection region extends upward with a predetermined inclination from the first end region and is connected to the second end region.

Moreover, an inclination angle of the connection region is different from an inclination angle of the first end region and an inclination angle of the second end region.

Furthermore, the driving unit includes: a driving body to which the door unit is rotatably coupled; a rail formed along an inner upper end of the accommodation part and providing a moving path of the driving body; and a motor for moving the driving body on the rail.

Additionally, a coupling unit is provided at an upper end of the door unit and extends upward to a predetermined length to be rotatably coupled to the driving body, and the driving body tows the coupling unit while moving toward the inside of the accommodation part along the rail to move the upper end of the door unit toward the inside of the accommodation part, and to move the lower end of the door unit upward along the guide unit.

In addition, a first coupling groove and a second coupling groove corresponding to each other are respectively formed in the coupling unit and the driving body, and a coupling bolt is fastened through the first coupling groove and the second coupling groove so that the coupling unit is rotatably coupled to the driving body.

Moreover, the driving unit further includes a driving marker extended to the outside of the driving body and detected by a door detection unit provided on a side surface of the rail, wherein in a case in which the driving marker is detected by the door detection unit at the first position or the second position by the movement of the driving body, the movement of the door unit is terminated.

Furthermore, at least one object detection unit for detecting an object is provided on a rear surface of the door unit facing the inside of the accommodation part at the first position.

Additionally, at least one dimming unit for irradiating light into the accommodation part is provided on a rear surface of the door unit facing the inside of the accommodation part at the first position.

In addition, the door apparatus further includes a towing unit having a first end connected to the driving unit and a second end connected to the door unit to tow the door unit according to driving of the driving unit, thereby assisting the movement of the door unit.

### Advantageous Effects

According to the present invention, when the door unit is opened, the upper end of the door unit moves into the accommodation part, and the lower end of the door unit moves upward so that the door unit can overlap the inside of the accommodation part only at a predetermined height or more. Accordingly, even if the door unit is opened or closed in a state in which an object is arranged inside the accommodation part, the door unit can avoid the object and the object does not fall down or move by the door unit.

In addition, according to the present invention, in the process of opening and closing the door unit, the rear surface of the door unit provided with the object detection unit and the dimming unit may always face the inside of the accommodation part, and thus the object may always be detected during the opening and closing process of the door unit, and light may be irradiated into the accommodation part.

### DESCRIPTION OF DRAWINGS

Brief description of drawings will be provided in order to sufficiently understand the drawings cited in the detailed description of the present invention.

FIG. 1 is a perspective view of a door apparatus according to an embodiment of the present invention.

FIG. 2 is a perspective view of a door apparatus according to an embodiment of the present invention.

FIG. 3 is a perspective view of a door unit according to an embodiment of the present invention.

FIG. 4 is a perspective view of a guide unit according to an embodiment of the present invention.

FIGS. 5A-5C are views illustrating the operation of the door apparatus according to an embodiment of the present invention.

FIG. 6 is a perspective view of a door apparatus according to an embodiment of the present invention.

FIG. 7 is a perspective view of a container collecting apparatus according to an embodiment of the present invention.

FIG. 8 is a perspective sectional view of the container collecting apparatus according to the embodiment of the present invention.

### MODE FOR INVENTION

Hereinafter, exemplary embodiments according to the present invention will be described in detail with reference to the contents disclosed in the accompanying drawings. In addition, a method of configuring and using an apparatus according to an embodiment of the present invention will be described in detail with reference to the accompanying drawings. Like reference numerals or symbols presented in the drawings denote parts or components that perform substantially the same functions. For convenience of description, the upward, downward, leftward, and rightward directions are written based on the drawings, and the scope of the present invention is not limited by the corresponding directions.

It will be understood that, although the terms first, second, etc. may be used herein to describe various elements, these elements should not be limited by these terms. These terms are only used to as labels distinguish one element from another. For example, a first signal could be termed a second signal, and, similarly, a second signal could be termed a first signal without departing from the teachings of the disclosure. The term “and/or” includes a combination of a plurality of related items or any one item among a plurality of related items.

The terms used herein are used to describe embodiments, and are not intended to limit and/or restrict the present invention. The singular forms are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In the description of the present invention, to connect some part with another part means that some part is directly connected with another part and that some part is indirectly connected with another part through an element. Furthermore, unless otherwise defined herein, to include a component does not mean that the mortise lock excludes other component but means that the mortise lock can include other components more.

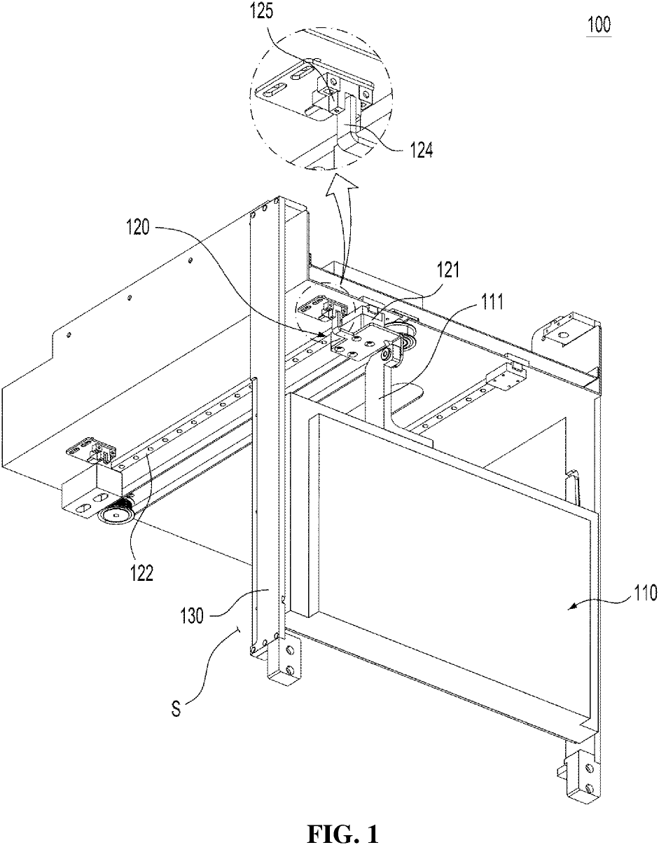

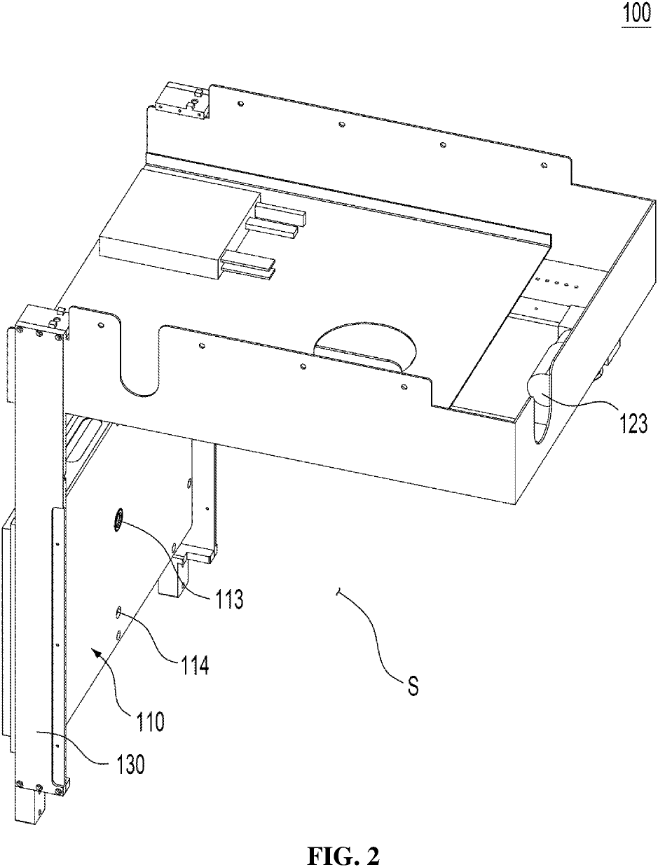

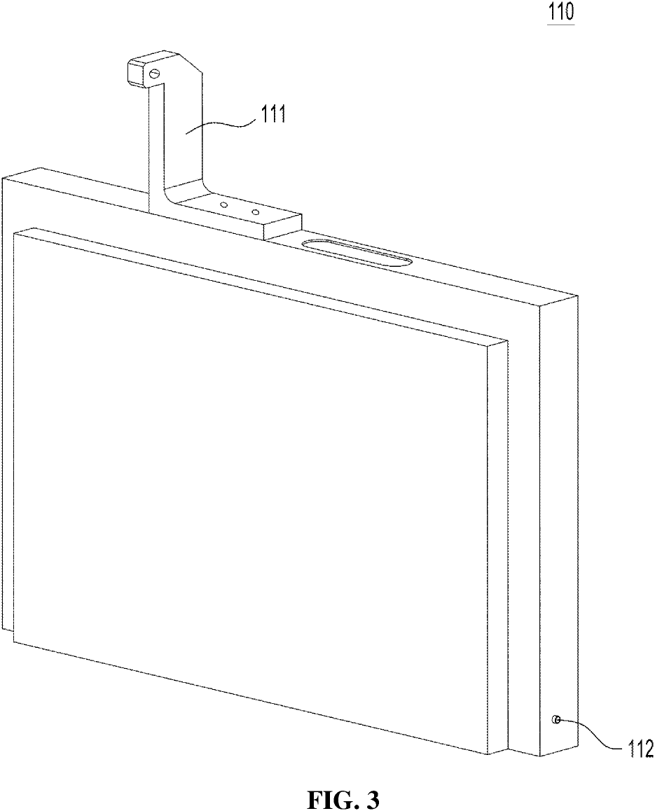

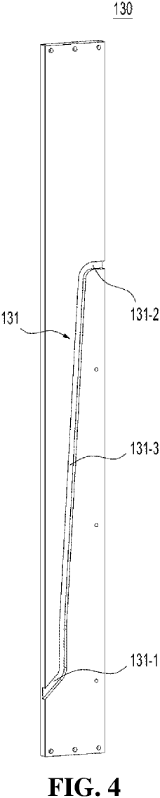

FIG. 1 is a perspective view of a door apparatus according to an embodiment of the present invention, FIG. 2 is a perspective view of a door apparatus according to an embodiment of the present invention, FIG. 3 is a perspective view of a door unit according to an embodiment of the present invention, and FIG. 4 is a perspective view of a guide unit according to an embodiment of the present invention.

Referring to FIGS. 1 to 4, a door apparatus 100 may include a door unit 110, a driving unit 120, and a guide unit 130.

The door unit 110 can open and close an accommodation part S. In this instance, the accommodation part S can at least temporarily accommodate an object (e.g., a multi-use container, etc.).

In an embodiment, the door unit 110 can move between a first position and a second position. In the first position, the accommodation part S may be closed, and in the second position, the accommodation part S may be opened. Specifically, in the first position, the door unit 110 is disposed at an inlet of the accommodation part S to close the accommodation part S, and in the second position, the door unit 110 is disposed at the inner upper end of the accommodation part S to open the accommodation part S.

In an embodiment, the door unit 110 may overlap the inside of the accommodation part S only at a predetermined height or more. That is, even if a process of opening and closing the door unit 110 is performed in a state in which an object (for example, a multi-use container or the like) is disposed inside the accommodation part S, the door unit 110 may avoid the object, and the object may not fall down or may not move by the door unit 110. Specifically, when the door unit 110 moves from the first position to the second position, the upper end of the door unit 110 moves toward the inside of the accommodation part S, and the lower end of the door unit 110 moves toward the upper side of the inlet of the accommodation part S, so that the overlapping range between the door unit 110 and the inside of the accommodation part S can be adjusted.

In an embodiment, at the first position, the front surface of the door unit 110 faces the outside, and the rear surface of the door unit 110 faces the inside of the accommodation part S. In addition, at the second position, the front surface of the door unit 110 faces upward, and the rear surface of the door unit 110 faces downward. That is, in a process in which the door unit 110 moves from the first position to the second position, the rear surface of the door unit 110 may always face the inside of the accommodation part S.

In an embodiment, the door unit 110 may include a coupling unit 111, a guide protrusion 112, an object detection unit 113, an operation detection unit 114, and/or a dimming unit (not shown).

The coupling unit 111 can couple the door unit 110 to the driving unit 120. In this instance, the coupling unit 111 can be rotatably coupled to the driving unit 120 (particularly, a driving body 121) while extending upward from the upper end of the door unit 110 to a predetermined length. In this case, the driving unit 120 may pull the coupling unit 111 to move the upper end of the door unit 110 to the inside of the accommodation part S. In particular, since the coupling unit 111 extends a predetermined length to increase the radius of rotation of the upper end of the door unit 110, interference of the door unit 110 by the driving body 121 or the inlet of the accommodation part S can be prevented.

The guide protrusion 112 can couple the door unit 110 to the guide unit 130 and can guide the movement from the first position to the second position of the door unit 110. Here, for example, the guide protrusion 112 may be formed at the lower end of the side surface of the door unit 110. When the upper end of the door unit 110 is towed by the driving unit 120 and moved into the accommodation part S, the guide protrusion 112 moves upward along the guide unit 130, so that the lower end of the door unit 110 can move upward.

The object detection unit 113 can detect an object. For example, the object detection unit 113 may detect a position, a size, a state, a shape, and the like of an object. Also, for example, the object detection unit 113 may include at least one of a camera, an infrared sensor, and an ultrasonic sensor. In a case in which the object detection unit 113 includes a camera, the camera may capture an image of the inside of the receiving unit S and transmits the image to a server, and then the server can detect the object. In addition, the above is just exemplary, and the object detection unit 113 according to the present invention may include all known equipment capable of detecting an object.

The motion detection unit 114 may detect an operation of the object inside the accommodation part S. For example, the motion detection unit 114 may detect that a portion of a human body (e.g., the hand) moves inside the accommodation part S. In a case in which the motion detection unit 114 detects movement of a portion of the human body, the door unit 110 stops the movement to prevent the human body from being jammed. In addition, in a case in which the movement of the human body is detected by the motion detection unit 114 after the object is recognized by the object detection unit 113, the movement of the door unit 110 may be stopped or a predetermined warning sound may be generated. For example, the motion detection unit 114 may include at least one among a camera, an infrared sensor, and an ultrasonic sensor, and may further include all known equipment capable of detecting the operation of the object.

The dimming unit may irradiate light into the accommodation part S. As the dimming unit irradiates light into the accommodation part S, the object detection unit 113 and/or the motion detection unit 114 can easily detect the object. For example, the dimming unit may include lighting such as an LED lamp, a fluorescent lamp, or an incandescent lamp, and at least one lighting unit may be arranged inside the door unit 110, but the present invention is not limited thereto. In addition, in a case in which the dimming unit is provided inside the door unit 110, the rear surface of the door unit 110 may be a transparent or translucent diffusion plate, but the present invention is not limited thereto

For example, the object detection unit 113, the motion detection unit 114, and/or the dimming unit may be provided on the rear surface of the door unit 110. Since the rear surface of the door unit 110 always faces the inside of the accommodation part S between the first position and the second position, the object detection part 113, the motion detection part 114, and/or the dimming part are also arranged to always face the inside of the accommodation part S, thereby continuously detecting the operation of the object and irradiating light into the accommodation part S.

The driving unit 120 is coupled to the door unit 110 to move the door unit 110.

In an embodiment, the driving unit 120 may include a driving body 121, a rail 122, and a motor 123.

The driving body 121 can move the door unit 110 by being coupled to the door unit 110 and moving along the rail 122. In this instance, the coupling unit 111 of the door unit 110 is rotatably coupled to the driving body 121, and the driving body 121 can tow the coupling unit 111 while moving inside the accommodation part S along the rail 122. As the coupling unit 111 is towed, the upper end of the door unit 110 can move into the accommodation part S.

The rail 122 provides a moving path of the driving body 121 and may extend along the upper end of the accommodation part S. For example, the rail 122 may extend inward from a point of the inlet of the accommodation part S.

The motor 123 can move the driving body 121 on the rail 122. For example, the motor 123 is a rotary motor, and may be connected to the driving body 121 via at least one belt pulley structure. For example, a first pulley may be provided at a front end of the accommodation part S, a second pulley may be provided at a rear end of the accommodation part S, and a connecting belt may connect the first pulley and the second pulley. In this instance, the motor 123 may drive the first pulley and/or the second pulley, and the driving body 121 may be attached to one side of the connection belt. However, the motor structure according to the present invention is not limited thereto, and any known structure capable of moving the driving body 121 on the rail can be applied.

In an embodiment, the coupling unit 111 and the driving body 121 respectively have a first coupling groove and a second coupling groove corresponding to each other, and a coupling bolt passes through the first coupling groove and the second coupling groove so that the coupling unit 111 can be rotatably coupled to the driving body 121. However, the present invention is not limited thereto, and all known coupling structures, such as hinge coupling and the like, can be applied to the coupling unit 111 and the driving body 121.

In an embodiment, the driving unit 120 may further include a driving marker 124 extending to the outside of the driving body 121. In addition, at least one door detection unit 125 may be provided on a side surface of the rail 122. In a case in which the door unit 110 is located at the first position or the second position, the driving marker 124 and the door detection unit 125 may be aligned with each other. For example, the door detection unit 125 includes a first detection sensor and a second detection sensor, wherein the driving marker 124 and the first detection sensor are aligned in the first position, and the driving marker 124 and the second detection sensor may be aligned in the second position. In this case, when the driving marker 124 is detected at the first position or the second position by the door detection unit 125 while the driving body 121 moves, the movement of the door unit 110 may be terminated.

The guide unit 130 is provided on both side surfaces of the inlet of the accommodation part S to guide the movement of the door unit 110.

In an embodiment, at least one guide groove 131 may be formed along the inner surface of the guide part 130. The guide protrusion 112 may be inserted into the guide groove 131. In a case in which the door unit 110 is towed by the driving unit 120, the guide protrusion 112 moves along the guide groove 131 so as to guide the movement of the door unit 110. More specifically, when the coupling unit 111 is towed by the driving unit 120 and the upper end of the door unit 110 moves to the inside of the accommodation part S, the guide protrusion 112 moves upward along the guide groove 131, so that the lower end of the door unit 110 can move upward.

In an embodiment, the guide groove 131 may include: a first end region 131-1 into which the guide protrusion 112 is inserted at the first position; a second end region 131-2 into which the guide protrusion 112 is inserted at the second position; and a connection region 131-3 for connecting the first end region 131-1 and the second end region 131-2. In this instance, the connection region 131-3 may extend upward with a predetermined inclination from the first end region 131-1 to be connected to the second end region 131-2. Accordingly, in a case in which the door unit 110 moves into the accommodation part S by the driving unit 120, the guide protrusion 112 may sequentially pass through the first end region 131-1, the connection region 131-3, and the second end region 131-2. In this instance, for example, when the door unit 110 is initially moved, the first end region 131-1 can prevent interference with the inlet of the accommodation part S, the connection region 131-3 can guide the upward movement of the lower end of the door unit 110, and the second end region 131-2 can maintain the arrangement state of the door unit 110 even if the door unit 110 is further moved when the door unit 110 is completely lifted.

In an embodiment, an inclination angle of the connection region 131-3 may be different from an inclination angle of the first end region (13-1) and an inclination angle of the second end region 131-2. For example, a first inclination angle of the first end region 131-1, a second inclination angle of the second end region 131-2, and a third inclination angle of the connection region 131-3 may be different from one another. For example, the third inclination angle may be the largest, and the first inclination angle may be the smallest. Accordingly, when the door unit 110 starts to move into the upper end accommodation part S by the driving unit 120, the guide protrusion 112 passes through the first end region 131-1 and the door unit 110 moves inward to a predetermined range, thereby preventing interference with the inlet of the accommodation part S when the door unit 110 moves later. Thereafter, when the upper end of the door unit 110 continuously moves into the accommodation part S, the guide protrusion 112 passes through the connection region 131-3 and the lower end of the door unit 110 may moves upward. Accordingly, the door unit 110 may be overlapped with the inside of the accommodation part S only at a predetermined height or more. Thereafter, in a case in which the lower end of the door unit 110 is sufficiently raised (for example, in a case in which the rear surface of the door unit 110 faces downward), the guide protrusion 112 moves along the second end region 131-2 so that only the position of the door unit 110 can be moved inward while the arrangement state of the door unit 110 is maintained.

The door apparatus 100 according to FIGS. 1 to 4 is just exemplary, and various configurations may be applied according to embodiments to which the present invention is applied.

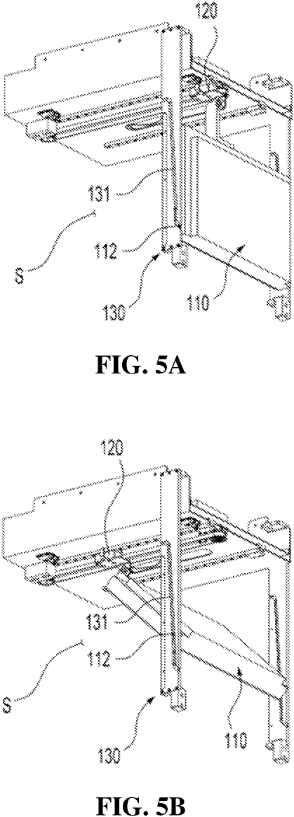

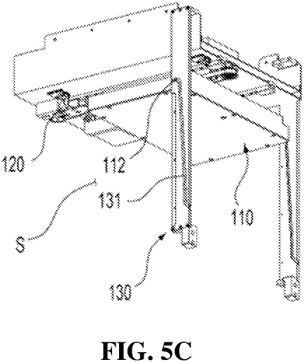

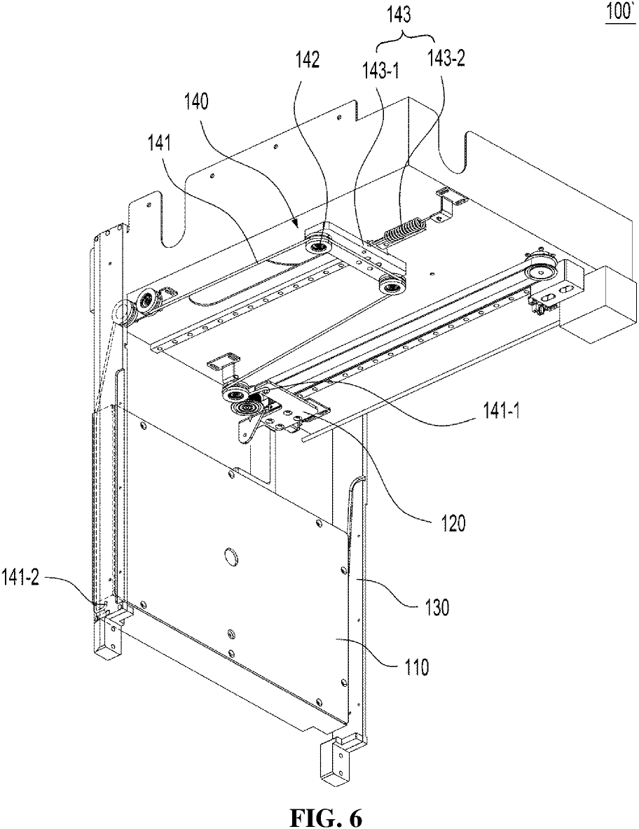

FIGS. 5A-5C are views illustrating the operation of a door apparatus according to an embodiment of the present invention.

Referring to FIGS. 5A-5C, the front surface of the door unit 110 may face the outside at the first position, and the rear surface of the door unit 110 may be disposed to face the inside of the accommodation part S. In this instance, the driving marker 124 and the first detection sensor may be aligned with each other.

Thereafter, when the driving body 121 moves into the accommodation part S along the rail 122, the driving body 121 may move the upper end of the door unit 110 into the accommodation part S by pulling the coupling unit 111, and at the same time, the guide protrusion 112 moves upward along the guide groove 131, so that the lower end of the door unit 110 can move upward.

Specifically, when the door unit 110 starts to move into the upper end accommodation part S by the driving unit 120 (See FIGS. 5A-5C), the guide protrusion 112 passes through the first end region 131-1 and the door unit 110 is moved inward to a predetermined range, thereby preventing interference with the inlet of the accommodation part S when the door unit 110 moves later.

Thereafter, when the upper end of the door unit 110 continues to move into the accommodation part S, the guide protrusion 112 passes through the connection area 131-3 and the lower end of the door unit 110 can move upward. Accordingly, the door unit 110 can be overlapped with the inside of the accommodation part S only at a predetermined height or more.

Thereafter, in a case in which the lower end of the door unit 110 is sufficiently raised (See FIG. 5C), the guide protrusion 112 moves along the second end region 131-2 so that only the position of the door unit 110 can move inward while the arrangement state of the door unit 110 is maintained.

In the second position, the front surface of the door unit 110 faces upward, and the rear surface of the door unit 110 faces downward. The driving marker 124 and the second detection sensor can be aligned with each other.

The operation of the door device 100 according to FIGS. 5A-5C is just exemplary, and various operation methods may be applied according to embodiments to which the present invention is applied.

FIG. 6 is a perspective view of a door apparatus according to an embodiment of the present invention.

Referring to FIG. 6, the door apparatus 100′ may include a door unit 110, a driving unit 120, a guide unit 130, and a towing unit 140. Here, the door unit 110, the driving unit 120, and the guide unit 130 may be described in the same manner as in FIGS. 1 to 5.

The towing unit 140 may assist the movement of the door unit 110. To that end, the towing unit 140 can pull the door unit 110 according to the driving of the driving unit 120.

In an embodiment, the towing unit 140 may include a wire 141, a pulley 142, and a buffer part 143.

The wire 141 allows a first end portion 141-1 to be connected to the driving unit 120, particularly, to the driving body 121, and a second end portion 141-2 to be connected to the door unit 110, particularly to the lower end of the door unit 110. Accordingly, when the driving body 121 moves into the accommodation part S along the rail 122, the first end portion 141-1 of the wire 141 may move into the accommodation part S together with the driving body 121. Accordingly, the lower end of the door portion 110 connected to the second end portion 141-1 of the wire 141 may move upward together with the second end portion 141-1 of the wire 141.

The wire 141 may be wound around the pulley 142, and the traveling direction of the wire 141 may be changed by the pulley 142. For example, when the traveling direction of the wire 141 is changed, the wire 141 can be connected to an edge of the door unit 110, thereby minimizing the exposure of the wire 141 to the outside. In addition, for example, even if the driving body 121 and the door unit 110 are not aligned, since the traveling direction of the wire 141 is changed by the pulley 142, the door unit 110 can receive an external force perpendicular to the door unit 110. Accordingly, a loss of force acting on the door unit 110 may be minimized. For example, a plurality of pulleys 142 are arranged on the upper side of the accommodation part S, and the traveling direction of the wire 141 can be changed multiple times.

The buffer part 143 may mitigate excessive transfer of the external force by the wire 141. For example, the buffer part 143 may include: a buffer plate 143-1 having at least one pulley; and a spring 143-2 of which one end portion is connected to the upper end of the accommodation part S and the other end portion is connected to the buffer plate 143-1. In a case in which the wire 141 pulls the door unit 110 by the movement of the driving body 121, an external force directed toward the door unit 110 may be applied to the buffer plate 143-1 by the elastic force of the wire 141, and the buffer plate 143-1 may be supported by the spring 143-2 and move a predetermined distance toward the door unit 110. That is, the external force transferred to the door unit 110 via the wire 141 by the movement of the driving body 121 may be offset by the elastic force of the wire 141 and the movement of the buffer plate 143-1, thereby mitigating an excessive external force transferred to the door unit 110 by the wire 141.

The door apparatus 100′ according to FIG. 6 is just exemplary, and various configurations may be applied according to embodiments to which the present invention is applied.

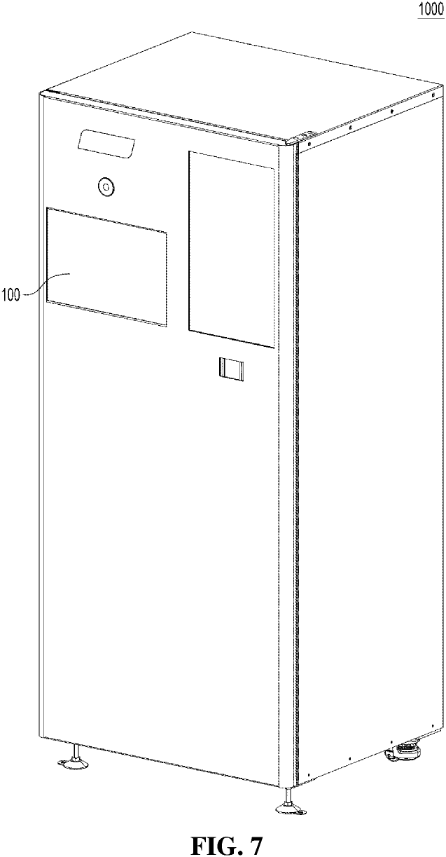

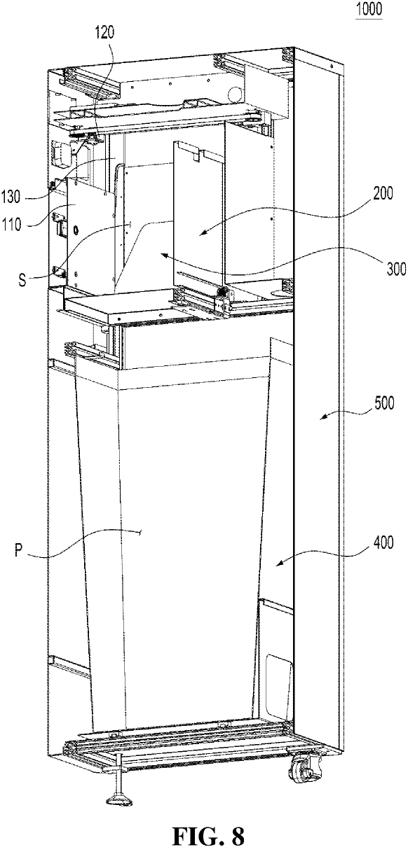

FIG. 7 is a perspective view of a container collecting apparatus according to an embodiment of the present invention, and FIG. 8 is a perspective sectional view of the container collecting apparatus according to the embodiment of the present invention.

Referring to FIGS. 7 and 8, the container collecting apparatus 1000 may include a door unit 100, an inner housing 200, a transfer unit 300, a collection unit 400, and an outer housing 500. Here, the door apparatus 100 may be described in the same manner as in FIGS. 1 to 5.

The inner housing 200 includes an accommodation part S therein so as to at least temporarily accommodate a container inserted thereinto by a user. In this instance, for example, the container may be a container made of one among various materials, such as a plastic material such as PET, HDPE, PVC, PP, or the like, and a metal material such as cast iron, aluminum, stainless steel, and the like, and may be a container used for various purposes such as disposable use, multi-use, a closed medicine case, for cooking, and the like.

The transfer unit 300 may move the container put into the inner housing 200. For example, the transfer unit 300 may transfer the container, put into the inner housing 200, to the collection unit 400 while reciprocating along the accommodation part S.

The collection unit 400 is provided at the lower side of the inner housing 200 to collect the container transferred from the inner housing 200 by the transfer part 300. The container collected in the collection unit 400 can be collected and provided to a new user.

The outer housing 500 is provided to surround the inner housing 200, the transfer unit 300, and the collection unit 400, and a side surface of an inlet of the accommodation part S may be formed through the outer housing 500. The door apparatus 100 may be disposed on the perforated surface of the outer housing 500.

The container collecting apparatus 1000 according to FIGS. 7 and 8 is just exemplary, and various configurations may be applied according to embodiments to which the present invention is applied. For example, instead of the door apparatus 100 of FIGS. 1 to 5, the door apparatus 100′ of FIG. 6 may be disposed in the container collecting apparatus 1000, or the door apparatus 100 may be disposed in a door structure of various mechanical devices or an entrance of a building besides the container collecting apparatus 1000.

The present invention has been particularly shown and described with reference to exemplary embodiments thereof. Although specific terms are used herein, they are just used for the purpose of describing the present invention and are not used to limit the scope of the present invention as set forth in the claims. Therefore, it will be understood by those of ordinary skill in the art that various changes and modifications may be made therein without departing from the technical idea and scope of the present invention. Therefore, the true technical protection scope of the present invention should be determined by the technical spirit of the appended claims.

1. A door apparatus comprising:
a door unit moving between a first position for closing an accommodation part, which at least temporarily accommodates an object, and a second position for opening the accommodation part;
a driving unit coupled to the door unit to move the door unit; and
a guide unit provided on both sides of an inlet of the accommodation part to guide the movement of the door unit,
wherein the door unit is disposed at the inlet of the accommodation part at the first position to close the accommodation part, and is disposed at an inner upper end of the accommodation part at the second position to open the accommodation part.

2. The door apparatus according to claim 1, wherein in a case in which the door unit moves from the first position to the second position, the upper end of the door unit moves toward the inside of the accommodation part and the lower end thereof moves toward the upper side of the inlet, so that the door unit overlaps the inside of the accommodation part only at a predetermined height or more.

3. The door apparatus according to claim 2, wherein the rear surface of the door unit facing the inside of the accommodation part at the first position is arranged to face downward from the second position.

4. The door apparatus according to claim 1, wherein at least one guide protrusion is formed at a lower end of a side surface of the door unit, and at least one guide groove into which the guide protrusion is inserted is formed along an inner surface of the guide unit.

5. The door apparatus according to claim 4, wherein the guide groove comprises: a first end region into which the guide protrusion is inserted at the first position; a second end region in which the guide protrusion is inserted at the second position; and a connection region connecting the first end region and the second end region, and
wherein the connection region extends upward with a predetermined inclination from the first end region and is connected to the second end region.

6. The door apparatus according to claim 5, wherein an inclination angle of the connection region is different from an inclination angle of the first end region and an inclination angle of the second end region.

7. The door apparatus according to claim 4, wherein the driving unit comprises: a driving body to which the door unit is rotatably coupled; a rail formed along an inner upper end of the accommodation part and providing a moving path of the driving body; and a motor for moving the driving body on the rail.

8. The door apparatus according to claim 7, wherein a coupling unit is provided at an upper end of the door unit and extends upward to a predetermined length to be rotatably coupled to the driving body, and
wherein the driving body tows the coupling unit while moving toward the inside of the accommodation part along the rail to move the upper end of the door unit toward the inside of the accommodation part, and to move the lower end of the door unit upward along the guide unit.

9. The door apparatus according to claim 8, wherein a first coupling groove and a second coupling groove corresponding to each other are respectively formed in the coupling unit and the driving body, and
wherein a coupling bolt is fastened through the first coupling groove and the second coupling groove so that the coupling unit is rotatably coupled to the driving body.

10. The door apparatus according to claim 7, wherein the driving unit further comprises a driving marker extended to the outside of the driving body and detected by a door detection unit provided on a side surface of the rail, and
wherein in a case in which the driving marker is detected by the door detection unit at the first position or the second position by the movement of the driving body, the movement of the door unit is terminated.

11. The door apparatus according to claim 1, wherein at least one object detection unit for detecting an object is provided on a rear surface of the door unit facing the inside of the accommodation part at the first position.

12. The door apparatus according to claim 1, wherein at least one dimming unit for irradiating light into the accommodation part is provided on a rear surface of the door unit facing the inside of the accommodation part at the first position.

13. The door apparatus according to claim 1, further comprising:
a towing unit having a first end connected to the driving unit and a second end connected to the door unit to tow the door unit according to driving of the driving unit, thereby assisting the movement of the door unit.
